(19) United States
(12) Patent Application Publication
(10) Pub. No.: US 2025/0074780 A1
(43) Pub. Date: Mar. 6, 2025

(54) Recovery of Ammonium Compounds

(71) Applicant: American Plant Food Corporation, Galena Park, TX (US)

(72) Inventors: Larry Unruh, Bryan, TX (US); Gregory Scott Peeden, Florence, AL (US); Daniel Lewey, Florence, AL (US); Andrew Michael Huey, Florence, AL (US); Rod Eggen, Houston, TX (US); Jerry Bilicek, Galena Park, TX (US)

(21) Appl. No.: 18/814,066

(22) Filed: Aug. 23, 2024

Related U.S. Application Data
(60) Provisional application No. 63/580,591, filed on Sep. 5, 2023.

(51) Int. Cl. C01C 1/24

(52) U.S. Cl. CPC C01C 1/24; C01P 2006/80

(57) ABSTRACT

Methods of purifying ammonium products, such as ammonium sulfate, from an aqueous ammonium-containing process stream are described. The process stream may be a waste stream from an industrial process, such as from acrylonitrile production, for example. Such process streams typically contain a number of organic contaminants. The methods involve removing water from the process stream and then treating the process stream to oxidatively destroy the organic contaminants. In the described methods, the oxidant used is a strong acid, such as concentrated sulfuric acid. The acid is added at a concentration and rate that is effective at oxidatively removing the organic carbon in the stream while avoiding complications from competing side reactions. Once the process stream is sufficiently free of such contaminants, the ammonium products can be granulated.

### CROSS REFERENCE TO RELATED APPLICATIONS

This is a non-provisional application of U.S. Provisional Patent Application Ser. No. 63/580,591, filed Sep. 5, 2023, which is incorporated by reference, and to which priority to claimed.

### FIELD OF THE INVENTION

This application relates to the recovery of useful products from a waste stream, and more specifically, to the recovery of ammonium sulfate from a waste stream of an acrylonitrile synthesis.

### INTRODUCTION

Processes and catalysts for the manufacture of acrylonitrile and methacrylonitrile by the ammoxidation of propylene and isobutylene, respectively, are described in U.S. Pat. Nos. 3,152,170; 3,153,085; 3,179,419; 3,198,750; 3,200,081; 3,200,084; 3,200,141 and British Patent 987,960. In the acrylonitrile manufacturing process, feed comprising propylene, ammonia and air is led into a fluidized bed reactor wherein the ammoxidation of propylene yields acrylonitrile including some byproducts and unreacted ammonia, nitrogen, etc. This reactor effluent stream is heat-exchanged with incoming reactants in a shell-and-tube heat exchanger and the cooled effluent, at about 300-600° F., is led into the bottom of a quench tower. Here the reactor effluent gases flow upward and countercurrent to a downflowing stream of dilute sulfuric acid. Substantially all of the ammonia not reacted in the reactor is neutralized with the sulfuric acid forming ammonium sulfate, which stays in solution in the water stream. Some acrylonitrile is also dissolved in this stream with relatively non-volatile and relatively heavy water-soluble compounds formed as byproducts.

The bottoms from the quench tower containing dissolved ammonium sulfate and organic heavies is pumped from the bottom at a temperature of about 100-180° F. The major portion of this stream is recycled back to the top of the quench tower, the other portion being led to a wastewater column. A makeup stream comprising dilute sulfuric acid is continually sprayed into the top of the quench tower. The wastewater column is typically a conventional distillation column wherein desirable volatile organics such acrylonitrile, acetonitrile, and the like are distilled off, with about 25 to 90 percent of the feed to the column being taken overhead and led to an absorber. The bottoms from the wastewater column contain ammonium sulfate, water and dissolved heavy organic matter. For example, this stream may contain from about 2 to about 20 percent ammonium sulfate, from about 80 to about 90 percent water with dissolved light and heavy organic compounds in solution.

Ammonium sulfate has a number of commercial uses but is mainly used as a fertilizer in agriculture to provide nitrogen and sulfur. Thus, there is a motivation to isolate the ammonium sulfate (and other useful ammonium products) from industrial streams that contain ammonium compounds. Examples of such streams include waste streams that occur during acrylonitrile production and other processes. Examples include the wastewater column bottoms (WWCB) streams, slip streams, and/or side streams. The treatment of such streams to recover ammonium sulfate (and other ammonium products) also has the benefit in some cases of allowing the recycling/reuse of the waste stream(s). To obtain commercially viable ammonium sulfate from such streams, it is necessary to separate/isolate the ammonium sulfate from the organic compounds in the stream. Some commercial processes for removing organic impurities from such streams involve oxidation treatment of waste stream, typically by using air as a source of oxygen for accomplishing the oxidation. Other treatments may involve using pure oxygen or an oxygen enriched gas as the oxidant. See for example U.S. Pat. Nos. 4,384,959; 3,042,489; 3,097,988; 3,654,070; 3,359,200; 3,272,740; 4,395,339 and 4,744,909. The use of pure oxygen or an oxygen enriched gas offers the advantage of faster and more complete oxidation, but also presents safety concerns. Accordingly, there is a need in the art for further methods and systems for removing impurities from ammonium sulfate-containing streams.

### SUMMARY

Disclosed herein is a method of purifying an ammonium compound from an aqueous ammonium-containing process stream, wherein the ammonium-containing process stream comprises water, one or more ammonium compounds, and one or more organic contaminants, the method comprising: evaporating a portion of the water from stream, combining an acid with the process stream to oxidize a portion of the organic contaminants, and removing further water from the process stream to provide granules of the ammonium compound. According to some embodiments, the ammonium compound is ammonium sulfate. According to some embodiments, the acid is concentrated sulfuric acid. According to some embodiments, the sulfuric acid is combined with the process stream at a mass ratio of about 0.80-1.20 parts sulfuric acid to 1 part process stream. According to some embodiments, combining the sulfuric acid and the process stream comprises mixing the sulfuric acid and the process stream in a pipe reactor. According to some embodiments, the method further comprises, following the pipe reactor, providing the process stream to a digester. According to some embodiments, the process stream is maintained in the digester for a residence time of at least 10 minutes. According to some embodiments, treating the process stream in the pipe reactor and the digester reduces total organic carbon (TOC) in process stream from a value of greater than 1% TOC to value of less than 1% TOC. According to some embodiments, treating the process stream in the pipe reactor and the digester reduces TOC in process stream from a value of greater than 3% TOC to value of less than 1% TOC. According to some embodiments, the method further comprises adding a secondary oxidant to the process stream in the pipe reactor and/or in the digester. According to some embodiments, the secondary oxidant is a peroxide. According to some embodiments, the method further comprises, following the digester, adding ammonia to the process stream. According to some embodiments, adding ammonia to the process stream comprises mixing the process stream with ammonia in a pipe cross reactor. According to some embodiments, the ammonium compound is ammonium sulfate and wherein, following the pipe cross reactor, the process stream comprises about 20 to about 60% ammonium sulfate. According to some embodiments, the method further comprises, following the pipe cross reactor, providing the process stream to a granulator to form granules of the ammonium compound. According to some embodiments, the method further comprises providing a binder to the granulator. According to some embodiments, the ammonium compound is ammonium sulfate and wherein the granules comprise about 90 to about 99% ammonium sulfate. According to some embodiments, the process stream is a waste stream derived from an industrial process. According to some embodiments, the industrial process is acrylonitrile production. According to some embodiments, the process stream is a waste-water column bottoms (WWCB) stream, a side-stream, and/or a slip stream.

Also disclosed herein is a system configured to perform the steps described herein for purifying an ammonium compound from an aqueous ammonium-containing process stream.

### BRIEF DESCRIPTION OF THE DRA WINGS

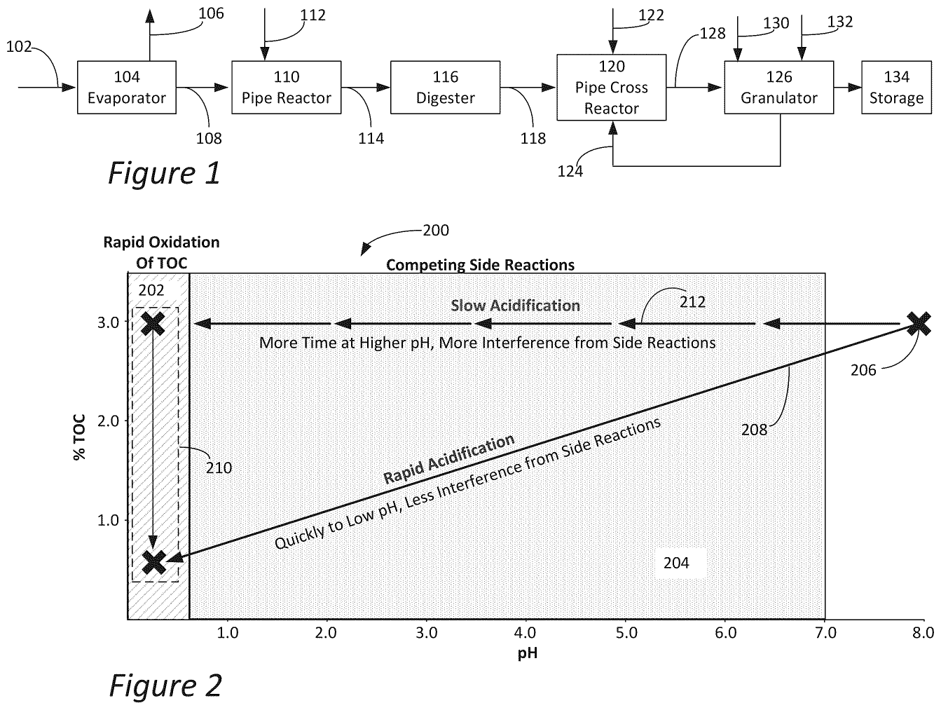

FIG. 1 shows an embodiment of an ammonium sulfate purification process.

FIG. 2 is a graph showing competing reactions based on the rate of acidification of a feed stream.

### DETAILED DESCRIPTION

Aspects of this disclosure relate to methods, processes, and equipment for recovering useful ammonium products, such as ammonium sulfate, from streams that contain ammonium compounds. Such streams are referred to herein as “ammonium-containing streams.” According to some embodiments, the ammonium-containing streams are waste streams derived from industrial processes. One example is waste streams generated during the production of acrylonitrile. For example, the ammonium-containing stream may be a wastewater column bottoms (WWCB) stream, a side-stream, a slip stream, or the like, derived from such a process.

FIG. 1 illustrates an embodiment of a process for isolating ammonium sulfate from an ammonium-containing stream. In the illustrated embodiment, the ammonium-containing stream contains ammonium sulfate, so it is referred to as an ammonium sulfate-containing stream 102. According to some embodiments, the ammonium sulfate-containing stream is an aqueous stream that comprises ammonium sulfate and one or more contaminants, including one or more organic compounds. According to some embodiments, the ammonium sulfate-containing stream 102 comprises about 2 to about 20 percent ammonium sulfate, about 80 to about 95 percent water, and about 0 to about 10 percent organic carbon. The ammonium sulfate-containing feed stream 102 may also include solids, such as suspended and/or dissolved solids. According to some embodiments, the ammonium sulfate-containing stream 102 may be a waste stream (as described above) from acrylonitrile production, and thus, will contain organic compounds characteristic of such streams. For example, the ammonium sulfate-containing stream 102 may contain mg/l to g/l concentrations of one or more of cyanide, acrylonitrile, acetonitrile, acrylamide, acrolein, pyridine, pyrazole, acrylic acid, acetic acid, and the like. If the ammonium sulfate-containing stream 102 is from another process, then the organic profile of the stream may be different.

In the illustrated embodiment, the ammonium sulfate-containing stream 102 is provided to an evaporator 104 via suitable piping. The ammonium sulfate-containing stream 102 may generally be any temperature, but in the context of acrylonitrile production, the stream 102 may typically be about 50 to 250° F. The evaporator 104 may generally be any type of evaporation apparatus known in the art. The evaporator may be configured to heat the ammonium sulfate-containing stream 102 with steam (not shown) to remove about 50-80% of the feed stream as an overhead distillate stream 106. The overhead stream 106 is generally mostly water, and may be further purified, recycled, and/or disposed of in accordance with local codes. The remainder of the contents of the evaporator 104 is provided as an evaporator concentrate stream 108. According to some embodiments, the evaporator concentrate stream 108 may comprise about 0-10% organics, 15-50% ammonium sulfate, and about 30-60% water. In some embodiments, the evaporator concentrate stream 108 may comprise about 3% or more of total organic carbon (TOC). According to some embodiments, the evaporator concentrate stream 108 may comprise a TOC of greater than 1% and/or greater than 3%. According to some embodiments, the TOC is about 1 to about 5% TOC. According to some embodiments, the evaporator concentrate stream 108 from the evaporator may be withdrawn at about 200-240° F., though lower temperatures may be used in some embodiments.

In the illustrated embodiment, the evaporator concentrate stream 108 is provided to a reactor 110. According to some embodiments, the reactor 110 may be a pipe reactor. An oxidant, in this case a strong acid, is introduced to the reactor 110 via piping 112. According to some embodiments, the oxidant is concentrated sulfuric acid, which is typically about 93 to about 99% sulfuric acid. In other embodiments, the addition of a neutralizing agent such as ammonia may be added as well. According to some embodiments, the sulfuric acid is provided at a standard mass ratio of about 1:1 to the evaporator bottoms stream 108. The process stream 114 from the reactor 110 is provided to a digester 116. According to some embodiments, the digester 116 comprises a vessel with nozzles in the most basic form. The digester may or may not have venting or gauges for measurement or be a pressure vessel. According to some embodiments, the digester 116 may be configured to provide a retention time of about 10 to about 20 minutes but in some instances may be shorter or longer duration dependent on material feeds, temperature, pressure, and other operating factors. It should be noted that other methods/equipment may be used to achieve similar residences/digestion times. For example, piping of an adequate length and/or flow rate may be used to provide the desired residence/digestion time without the need for a digestion vessel.

The purpose of the reactor 110 and the digester 116 is to oxidatively decrease the amount of TOC in the process stream via the reaction of the oxidant (i.e., sulfuric acid) with the carbon components in the process stream. The inventors have discovered that rapidly mixing near equal amounts of concentrated sulfuric acid with the process stream accomplishes the oxidation of the organic components and significantly lowering the solution's pH rapidly all while increasing temperature to minimize the impact of competing side reactions, such as polymerization and/or tar-forming reactions involving the organic compounds. A person of skill in the art will appreciate that it is counterintuitive to rapidly mix large amounts of a strong acid with an aqueous stream due to the highly exothermic behavior of such a process. Generally, a person of skill in the art would seek to introduce the acid slowly. However, combining the sulfuric acid and the aqueous feed streams in close to equal proportions, particularly using turbulence provided by the pipe reactor, allows the oxidation of the organic components to outpace the kinetics of the competing side reactions.

FIG. 2 graphically illustrates the benefit of rapid acidification of the evaporator concentrate stream 108. The graph 200 shows pH on the x-axis. The pH range is divided into two regimes. In the first pH regime 202, oxidation of carbon components within the evaporator concentrate stream occurs very rapidly. In the second pH regime 204, competing side reactions, such as polymerization and/or tar-forming reactions involving the organic compounds may favorably compete with the oxidation of the carbon components. It should be noted that the graph 200 and its illustrated pH regimes are intended as a qualitative illustration. In other words, the actual pH ranges for each regime may vary depending on the specific system involved. For example, the pH values of the regime 202 may extend to negative pH values.

In the illustrated embodiment, the evaporator concentrate stream has an initial pH of about 8 and an initial TOC concentration of about 3% TOC, as shown by point 206. According to some examples, if the evaporator concentrate stream is acidified rapidly, as indicated by the line 208, the system quickly reaches the regime 202, where the oxidation of organic matter within the evaporator concentrate stream outcompetes competing side reactions. In that favorable scenario, the reaction 210 dominates, whereby organic compounds are oxidized. In the illustrated example, the TOC is reduced to a value of about 0.5% TOC. By contrast, if the evaporator concentrate stream is acidified slowly (arrows 212), the system spends more time in the pH regime where competing side reactions compete favorably against the oxidation of organic compounds in the evaporator concentrate stream. As a consequence, the product is more contaminated with side products when the acidification occurs slowly.

Referring again to FIG. 1, examples of the disclosed process achieve the desired rapid acidification using the pipe reactor 110. In embodiments featuring a pipe reactor 110, control valves and flow meters (not shown) can control the flow rate (e.g., pounds per hour) of evaporator concentrate stream (line 108) and sulfuric acid (line 112) into the pipe reactor 110, such that essentially equal masses of concentrate stream and sulfuric acid are mixed essentially instantaneously and continuously in the pipe reactor. According to some embodiments, the mass ratio of concentrated sulfuric acid to evaporator concentrate stream continuously flowing into the pipe reactor is about 1:1. According to some embodiments, the ratio is about 0.5:1 to 2:1. According to some embodiments the ratio is 0.75:1 to 1.5:1. According to some embodiments the ratio is about 0.75:1 to 1.25:1. The nearly instantaneous mixing of a large quantity of concentrated sulfuric acid (relative to the amount of evaporator concentrate stream achieves the rapid acidification (drop in pH) described above, which minimizes the impact of competing side reactions.

It should be noted here that the process illustrated in FIG. 1 is a continuous process whereby sulfuric acid and the evaporator concentrate stream are continuously mixed in the pipe reactor. Other embodiments may include a batch process, whereby sulfuric acid is added quickly to a fixed volume (or mass) of evaporator concentrate in an adequately sized and equipped vessel with rapid mixing to achieve the desired mass ratios described above.

The oxidation performed in the reactor 110 and the digester 116 effects a substantial reduction in the organic carbon content (as TOC %) of the process stream. According to some embodiments, the reduction in TOC may be from about 60% to about 90% of the TOC originally in the evaporator concentrate stream 108, primarily occurring with respect to light volatile components of the stream. According to some embodiments, oxidation in the pipe reactor and the digester decreases the TOC from a value that is greater than 1% (or even greater than 3%) to a value that is less than 1%. Accordingly, the aqueous digester effluent 118 is substantially enriched in ammonium sulfate (AMS). For example, the digester effluent 118 may comprise about 0% to about 50% AMS, and according to some embodiments, about 8% to about 10% AMS. In the illustrated embodiment, the digester effluent is provided to a reactor 120, which in some embodiments may be a pipe cross reactor. The pipe cross reactor 120 serves to mix the digester effluent 118 with primary ammonia (and possibly water and/or steam), which is provided via line 122, and with recycled scrubber liquor 124 recycled from the granulator 126. The ammonia, water, and steam are added to balance/optimize the feed (i.e., the pipe cross reactor effluent 128) for the granulator 126. According to some embodiments, the pipe cross reactor effluent 128 may comprise about 20 to about 60% AMS, 10% to about 30% oxidizer, about 30 to about 50% water, and about 0 to about 10% other compounds. It should be noted that such other compounds may be beneficial as micronutrients within the final AMS fertilizer product. Examples of such other compounds may include zinc, iron, manganese and boron, among other compounds/elements.

The pipe cross reactor effluent 128 is provided to one or more granulators 126. It should be noted that even though a single granulator 126 is shown in the illustration, the granulation stage may comprise more than one granulator. Granulators for preparing AMS that is suitable for fertilizer applications are known in the art, so the granulator(s) 126 need not be described here in detail. Generally, the purpose of the granulator(s) 126 is to provide granules of AMS with suitable physical and chemical properties for the storage and handling of the AMS fertilizer materials. For example, remaining water is removed from the AMS solution in the granulator(s) 126. Supplemental ammonia and/or sulfuric acid 130 and binder 132 may be added to the granulator(s) 126. The binder serves to enhance the mechanical properties of the ammonium sulfate granules. Suitable binders include aluminum-based binders such as aluminum sulfate (alum). As mentioned above, recycled scrubber liquor 124 is recycled from the granulator 126. According to some embodiments, the scrubber liquor may comprise about 3% to about 20% AMS, 0% to about 5% oxidizer, about 80 to about 95% water, and about 0 to about 1% other compounds. From the granulator, the ammonium sulfate granules are conveyed to suitable finished product storage 134. According to some embodiments, the ammonium sulfate granules comprise about 90 to about 99% ammonium sulfate.

It will be appreciated that methods and equipment for the isolation of ammonium products from an ammonium-containing stream have been disclosed. As mentioned above, the ammonium-containing stream may be a waste stream from an industrial process, such as an acrylonitrile production. The advantages of the described methods are at least two-fold. First, they provide a commercially valuable product, namely, useful ammonium products, such as AMS. Secondly, a large portion of the waste stream, such as the overhead distillation stream 106 from the evaporator 104, comprises essentially water that is removed from the waste stream. The water can be economically purified and released back to the environment as opposed to needing to be stored, for example, in storage wells. Thus, the disclosed processes provide a significant environmental benefit, as well as a commercial benefit.

### EXAMPLES

Aspects of the disclosure will be understood in light of the following specific examples, which are merely illustrative and should not be construed as limiting the invention in any respect, as will be evident to those skilled in the art.

Table 1 below shows the oxidation/destruction of total organic carbon (TOC) from concentrated samples of waste-water column bottoms (WWCB). For the “50% concentrate” samples, the WWCB volume was reduced by 50% by evaporation/distillation. As shown in the table, the initial TOC concentration of the 50% concentrate WWCB sample was 21,200 ppm. For the ⅔ concentrate samples, the WWCB volume was reduced by ⅔ by evaporation/distillation until ⅓ of the original volume remained. The initial TOC concentration of the ⅔ concentrate WWCB sample was 26,800 ppm.

For each of the reactions, an appropriate amount of concentrated sulfuric acid was added to 300 mL of the WWCB sample to achieve the indicated mass ratio of sulfuric acid to WWCB sample (i.e., 1:1-300 mL, 0.75:1-225 mL, 0.50:1-150 mL, respectively of sulfuric acid). The requisite volume of sulfuric acid was dumped into each of the WWCB samples (i.e., the addition time was about a second). The resulting reaction mixture was brought to a boil and allowed to react for 15 minutes. The table shows the resulting concentration of TOC in each of the samples following the reaction. It will be noted that the greatest TOC reduction was achieved using a 1:1 mass ratio of sulfuric acid to WWCB. Generally, greater TOC reductions were observed with the more concentrated WWCB samples (i.e., with the ⅔ WWCB samples).

TABLE 1
Oxidation of waste-water column bottoms
(WWCB) with sulfuric acid.

| | | | TOC after |
|---|---|---|---|
| Ratio of | | Starting | reaction |
| sulfuric acid:WWCB | TOC Percent | TOC for | with sulfuric |
| (50% Concentrate) | Reduction | WWCB (ppm) | acid |
| 1:1 | 46.23% | 21200 | 11400 |
| 0.75:1 | 41.98% | 21200 | 12300 |
| 0.5:1 | 36.79% | 21200 | 13400 |
| | | | TOC after |
| Ratio of | | Starting | reaction |
| sulfuric acid:WWCB | TOC Percent | TOC for | with sulfuric |
| (2/3 Concentrate) | Reduction | WWCB (ppm) | acid |
| 1:1 | 61.94% | 26800 | 10200 |
| 0.75:1 | 51.12% | 26800 | 13100 |
| 0.5:1 | 41.42% | 26800 | 15700 |

Although particular embodiments of the present invention have been shown and described, it should be understood that the above discussion is not intended to limit the present invention to these embodiments. It will be obvious to those skilled in the art that various changes and modifications may be made without departing from the spirit and scope of the present invention. Thus, the present invention is intended to cover alternatives, modifications, and equivalents that may fall within the spirit and scope of the present invention as defined by the claims. It will be appreciated that some aspects and equipment of described processes that are not particularly relevant to this disclosure but that are implemented in the actual operation of such a system are not mentioned here. Such aspects and equipment are known in the art and may be described in the above-incorporated references. In particular, in the drawings lines are intended to represent appropriate piping, conduits, etc., along with the appropriate supporting equipment, as would be apparent to a person of skill in the art.

What is claimed is:

1. A method of purifying an ammonium compound from an aqueous ammonium-containing process stream, wherein the ammonium-containing process stream comprises water, one or more ammonium compounds, and one or more organic contaminants, the method comprising:
evaporating a portion of the water from stream,
combining an acid with the process stream to oxidize a portion of the organic contaminants, and
removing further water from the process stream to provide granules of the ammonium compound.

2. The method of claim 1, wherein the ammonium compound is ammonium sulfate.

3. The method of claim 1, wherein the acid is concentrated sulfuric acid.

4. The method of claim 3, wherein the sulfuric acid is combined with the process stream at a mass ratio of about 0.80-1.20 parts sulfuric acid to 1 part process stream.

5. The method of claim 3, wherein combining the sulfuric acid and the process stream comprises mixing the sulfuric acid and the process stream in a pipe reactor.

6. The method of claim 5, further comprising, following the pipe reactor, providing the process stream to a digester.

7. The method of claim 6, wherein the process stream is maintained in the digester for a residence time of at least 10 minutes.

8. The method of claim 5, wherein treating the process stream in the pipe reactor and the digester reduces total organic carbon (TOC) in process stream from a value of greater than 1% TOC to value of less than 1% TOC.

9. The method of claim 5, wherein treating the process stream in the pipe reactor and the digester reduces TOC in process stream from a value of greater than 3% TOC to value of less than 1% TOC.

10. The method of claim 5, further comprising adding a secondary oxidant to the process stream in the pipe reactor and/or in the digester.

11. The method of claim 10, wherein the secondary oxidant is a peroxide.

12. The method of claim 5, further comprising, following the digester, adding ammonia to the process stream.

13. The method of claim 12, wherein adding ammonia to the process stream comprises mixing the process stream with ammonia in a pipe cross reactor.

14. The method of claim 13, wherein the ammonium compound is ammonium sulfate and wherein, following the pipe cross reactor, the process stream comprises about 20 to about 60% ammonium sulfate.

15. The method of claim 13, further comprising, following the pipe cross reactor, providing the process stream to a granulator to form granules of the ammonium compound.

16. The method of claim 15, further comprising providing a binder to the granulator.

17. The method of claim 15, wherein the ammonium compound is ammonium sulfate and wherein the granules comprise about 90 to about 99% ammonium sulfate.

18. The method of claim 1, wherein the process stream is a waste stream derived from an industrial process.

19. The method of claim 18, wherein the industrial process is acrylonitrile production.

20. The method of claim 19, wherein the process stream is a waste water column bottoms (WWCB) stream, a side-stream, and/or a slip stream.
